(19) United States
(12) Patent Application Publication
(10) Pub. No.: US 2026/0298427 A1
(43) Pub. Date: Oct. 1, 2026

(54) MODULAR HUMANOID INTERACTIVE LAMP

(71) Applicant: ZAOMA LLC, Sheridan, WY (US)

(72) Inventors: Huajun OUYANG, Guangzhou (CN); Zhuoyi FAN, Guangzhou (CN); Jinmin LIANG, Guangzhou (CN); Xingxu LI, Guangzhou (CN); Hongsong YUAN, Guangzhou (CN); Jian MA, Guangzhou (CN)

(21) Appl. No.: 19/632,034

(22) Filed: Mar. 27, 2026

(30) Foreign Application Priority Data
Mar. 31, 2025 (CN) 202520598996.4

(51) Int. Cl. F21S 9/02; F21S 2/00; F21V 23/04

(52) U.S. Cl. CPC F21S 9/02; F21S 2/005; F21V 23/0464

(57) ABSTRACT

The present disclosure relates to a modular humanoid interactive lamp formed by combining anthropomorphic modular components, including a head, a torso, and the like through magnetic attraction by using a plurality of sets of magnetic attraction apparatuses, where modules may be separated or combined, and a plurality of lamps may also be combined for interactive use. In addition to interacting through various physical postures, the lamp in the present disclosure further achieves multi-modal interaction between products and between products and people through integrated control applications such as wireless control, voice recognition, and an environmental sensor. This provides a user with multi-scenario application value in home, education, and commerce, bringing more interesting and interactive user experience, and possesses high market and social value.

### TECHNICAL FIELD

The present disclosure relates to the field of lighting technology, and in particular, to a modular humanoid interactive lamp.

### BACKGROUND

Existing lamp products mostly focus on fully satisfying lighting needs, and there are some lamps with posture or motion interaction. However, there are few products that combine physical interactivity with intelligent remote network control and digital interaction.

With the development of industries and technologies, demands for lighting have become diversified and data-driven. How to enable products to provide more intelligent applications and emotional value beyond basic lighting needs is a key development direction for lighting design. Therefore, a highly modular, mobile Internet-enabled, and intelligent humanoid interactive lamp is provided to solve the above problems.

### SUMMARY

In view of this, the present disclosure provides a modular humanoid interactive lamp to solve the above problems.

Objectives of the present disclosure are achieved through the following technical solutions:

A modular humanoid interactive lamp includes:

a head, where a front of the head is provided with a face lens, a bottom of the head is provided with a first magnetic attraction apparatus, and an interior of the head is provided with a focusing apparatus; a first light source assembly is fixed to a front end of the focusing apparatus, and an integrated control assembly is fixed to a rear end of the focusing apparatus; and the integrated control assembly includes an environmental sensor, a voice recognition chip, and a wireless communication module;

a torso, where a top of the torso is provided with a head connection ball, and a back of the torso is provided with a second magnetic attraction apparatus; the second magnetic attraction apparatus is connected to an energy pack, a front of the energy pack is provided with a magnetic iron sheet for docking with the second magnetic attraction apparatus, a back of the energy pack is provided with a third magnetic attraction apparatus, the energy pack has a built-in lithium battery and a charging circuit, a bottom of the energy pack is provided with an energy pack cover and a charging port, and the energy pack is connected to the head through the third magnetic attraction apparatus and supplies power to the head; and the torso is provided with arms on two sides, and legs on two sides of the bottom, an end of the arm is provided with a fourth magnetic attraction apparatus, and a bottom of the leg is provided with a fifth magnetic attraction apparatus; and

a base, where the base is made of a magnetic metal material and can be connected through magnetic attraction to the fifth magnetic attraction apparatus to keep the lamp stably standing.

Specifically, an outermost layer of the focusing apparatus is provided with a focusing seat, a lead screw nut is fixed in an inner layer of the focusing seat, a lead screw is nested in the lead screw nut, a front end of the lead screw is connected and fixed to the first light source assembly, a rearmost end of the lead screw extends to the outside of the head and is fixedly connected to a focusing knob, and rotating the focusing knob can rotate the lead screw in a linkage manner and move the threaded tube back and forth, thereby driving the first light source assembly to move back and forth, realizing a focusing control function, changing a size of a spot emitted from the face lens, and adjusting an illumination area of the lamp.

Specifically, the integrated control assembly is electrically connected to the first light source assembly, the integrated control assembly extends a magnetic terminal wire to the outside of the head and is electrically connected to the third magnetic attraction apparatus, and the energy pack provides power support to the integrated control assembly through the third magnetic attraction apparatus.

More specifically, the environmental sensor automatically adjusts brightness based on light intensity, and the voice recognition chip controls on/off and brightness/color temperature adjustment of the first light source assembly according to a voice instruction.

Further, in some embodiments, the face lens can be detachably replaced with a projection lens, to project a dynamic image externally, and receive external device instructions and real-time updated content through the wireless communication module, thereby achieving remote information interaction and joint interaction among a plurality of lamps.

Further, a top of the energy pack is provided with a second light source assembly and a switch, and the energy pack can be removed and used as an independent mobile power bank and flashlight.

Further, the legs can rotate 360 degrees around the torso to assume a bending or kicking posture, and cooperates with the focusing apparatus of the head to jointly control an angle and a range of illumination, and meanwhile, legs of a plurality of lamps can be magnetically attracted to each other through the fifth magnetic attraction apparatus to form an array or a linked posture.

The beneficial effects of the present disclosure are as follows:

The present disclosure provides a modular humanoid interactive lamp that is formed by combining anthropomorphic modules such as a head and a torso, where modules may be separated or combined, and a plurality of lamps may also be combined for interactive use. In addition to interacting through various physical postures, the lamp in the present disclosure further achieves multi-mode interaction between products and between products and people through intelligent integrated control such as wireless networking, voice recognition, and an environmental sensor. This provides a user with multi-scenario application value in home, education, and commerce, bringing a more intelligent interactive experience, and expanding application boundaries of lamps, and possesses high market and social value.

### BRIEF DESCRIPTION OF DRAWINGS

The present disclosure is further described below in conjunction with the accompanying drawings and embodiments:

FIG. 1 is a schematic diagram of a structure of an embodiment of the present disclosure;

FIG. 2 is a schematic diagram of a structure in another angle of an embodiment of the present disclosure;

FIG. 3 is an exploded view of a structure of an embodiment of the present disclosure;

FIG. 4 is an exploded view of a structure in another angle of an embodiment of the present disclosure; and

FIG. 5 is a framework diagram of an integrated control assembly according to an embodiment of the present disclosure.

In the figures:

Head 1, face lens 11, projection lens 110, focusing apparatus 12, focusing seat 120, lead screw 121, lead screw nut 122, focusing knob 123, first light source assembly 13, integrated control assembly 14, environmental sensor 140, voice recognition chip 141, wireless communication module 142, first magnetic attraction apparatus 15, magnetic terminal wire 16, torso 2, head connection ball 21, second magnetic attraction apparatus 22, energy pack 23, magnetic iron sheet 230, lithium battery 231, charging circuit 232, second light source assembly 233, switch 234, energy pack cover 235, charging port 236, third magnetic attraction apparatus 237, arm 26, fourth magnetic attraction apparatus 260, leg 27, fifth magnetic attraction apparatus 270, and base 3.

### DETAILED DESCRIPTION OF THE EMBODIMENTS

To facilitate understanding by those skilled in the art, the present disclosure will be further described in detail below in conjunction with specific embodiments and accompanying drawings. Wherein the same or similar reference numerals represent the same or similar elements or elements with the same or similar functions throughout. The embodiments described below with reference to the accompanying drawings are exemplary and intended to explain the present disclosure, and should not be construed as limiting the present disclosure. In the descriptions of the disclosure, it should be understood that the terms "center," "upper," "lower," "front," "rear," "left," "right," "top," "bottom," "inner," "outer," and the like, indicating orientations or positional relationships, are based on the orientations or positional relationships shown in the accompanying drawings, and are only for the convenience of describing the present disclosure and simplifying the descriptions, and do not indicate or imply that the referred apparatus or component must have a specific orientation, or be constructed and operated in a specific orientation, and therefore cannot be understood as a limitation on the present disclosure.

In the present disclosure, unless otherwise explicitly specified and limited, terms such as "connected," "mounted," and "fixed" should be broadly understood. For example, "connected" can be a mechanical connection or an electrical connection, can be direct connection or indirect connection through an intermediate medium, and can be an internal connection or an external connection. For those skilled in the art, the specific meaning of the above terms in the present disclosure can be understood according to specific circumstances.

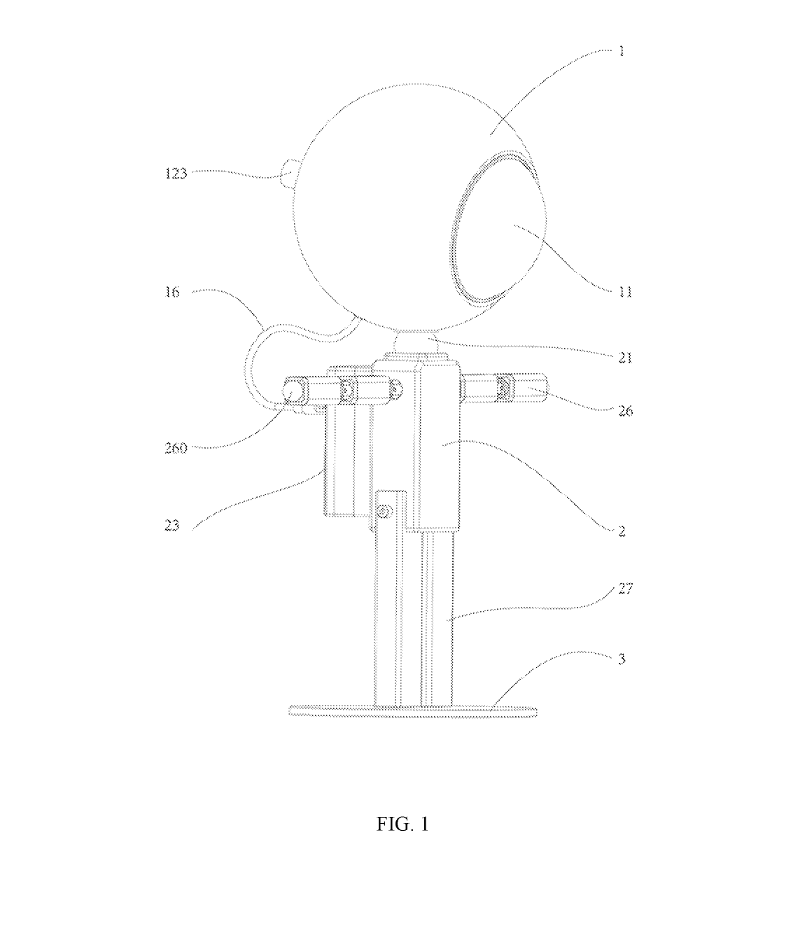

Please refer to FIG. 1 to FIG. 5. An embodiment of the present disclosure includes:

a head 1, where a front of the head 1 is provided with a face lens 11, a bottom of the head 1 is provided with a first magnetic attraction apparatus 15, and an interior of the head 1 is provided with a focusing apparatus 12; a first light source assembly 13 is fixed to a front end of the focusing apparatus 12, and an integrated control assembly 14 is fixed to a rear end of the focusing apparatus 12; and the integrated control assembly 14 includes an environmental sensor 140, a voice recognition chip 141, and a wireless communication module 142;

a torso, where a top of the torso 2 is provided with a head connection ball 21, and a back of the torso 2 is provided with a second magnetic attraction apparatus 22; the second magnetic attraction apparatus 22 is connected to an energy pack 23, a front of the energy pack 23 is provided with a magnetic iron sheet 230 for docking with the second magnetic attraction apparatus 22, a back of the energy pack 23 is provided with a third magnetic attraction apparatus 237, the energy pack 23 has a built-in lithium battery 231 and a charging circuit 232, a bottom of the energy pack 23 is provided with an energy pack cover 235 and a charging port 236, and the energy pack 23 is connected to the head 1 through the third magnetic attraction apparatus 237 and supplies power to the head 1; and the torso is provided with arms 26 on two sides, and legs 27 on two sides of the bottom, an end of the arm 26 is provided with a fourth magnetic attraction apparatus 260, and a bottom of the leg 27 is provided with a fifth magnetic attraction apparatus 270; and

a base, where the base 3 is made of a magnetic metal material and can be connected through magnetic attraction to the fifth magnetic attraction apparatus 270 to keep the lamp standing.

Please refer to FIG. 1 to FIG. 4. An outermost layer of the focusing apparatus 12 is provided with a focusing seat 120, a lead screw nut 122 is fixed in an inner layer of the focusing seat 120, a lead screw 121 is nested in the lead screw nut 122, a front end of the lead screw nut 122 is connected and fixed to the first light source assembly 13, a rearmost end of the lead screw 121 extends to the outside of the head 1 and is fixedly connected to a focusing knob 123, and rotating the focusing knob 123 can rotate the lead screw 121 in a linkage manner and move the lead screw nut 122 back and forth, thereby driving the first light source assembly 13 to move back and forth, realizing a focusing control function, changing a size of a spot emitted from the face lens 11, and adjusting an illumination distance of the lamp. This allows the lamp, in addition to being used as a desk lamp, to project weak light onto distant ceilings or walls in some cases and serve as ambient lighting, thereby expanding an application boundary of the lamp.

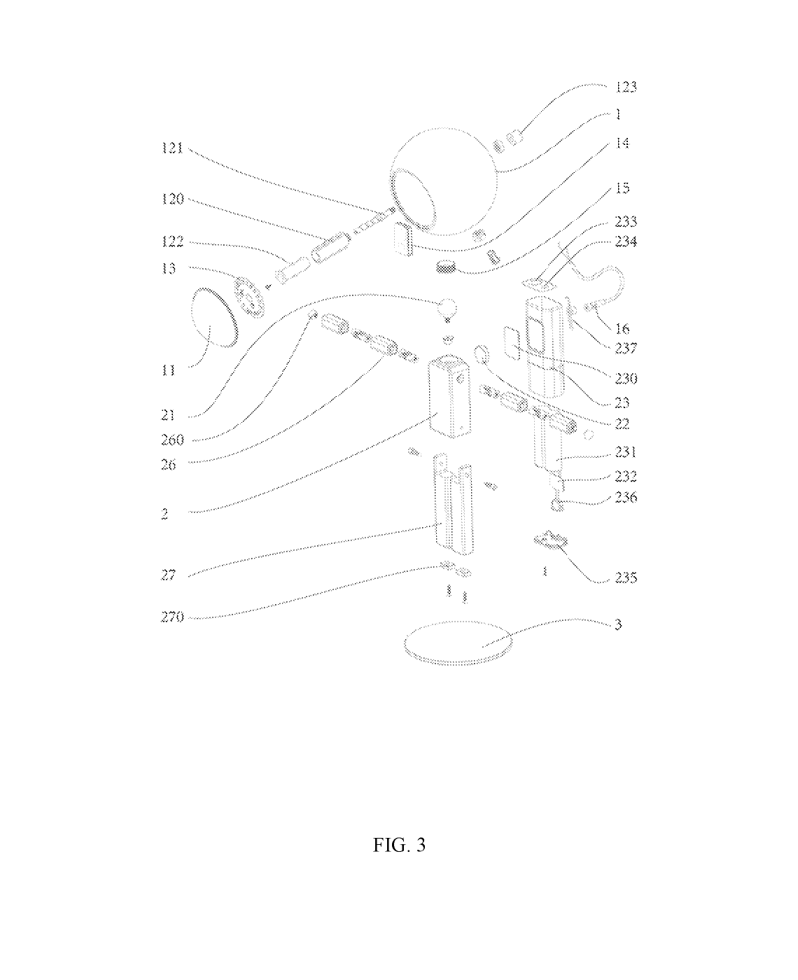

Please refer to FIG. 3 to FIG. 5. The integrated control assembly 14 is electrically connected to the first light source assembly 13, the integrated control assembly 14 extends a magnetic terminal wire 16 to the outside of the head 1 and is electrically connected to the third magnetic attraction apparatus 237, and the energy pack 23 provides power support to the integrated control assembly 14 through the third magnetic attraction apparatus 237.

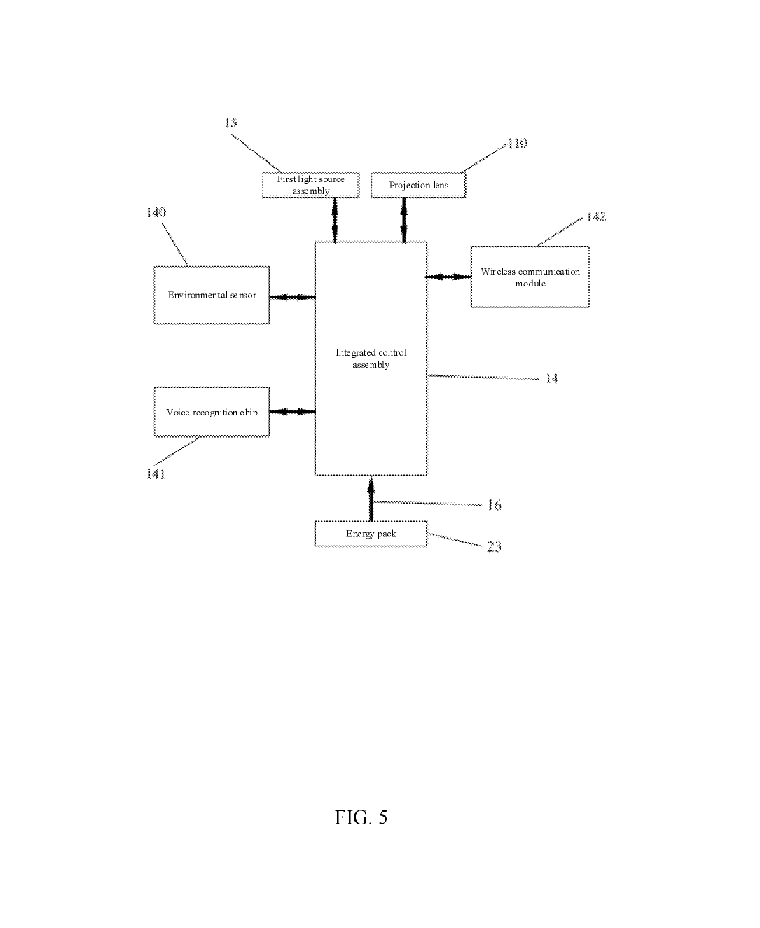

Please refer to FIG. 5. The environmental sensor 140 automatically adjusts brightness based on light intensity. The voice recognition chip 141 controls on/off and brightness/color temperature adjustment of the first light source assembly 13 according to a voice instructions. Under connection to the Internet, a user can further remotely perform turning on/off and adjustment through the wireless communication module 142.

Please refer to FIG. 1 and FIG. 5. The face lens 11 can be detachably replaced with a projection lens 110 to project a dynamic image externally, and receive an external device instruction and real-time updated content through the wireless communication module 142, thereby achieving remote information interaction and joint interaction among a plurality of lamps, to provide the user with a remote networked human-computer interaction application in gaming and educational scenarios.

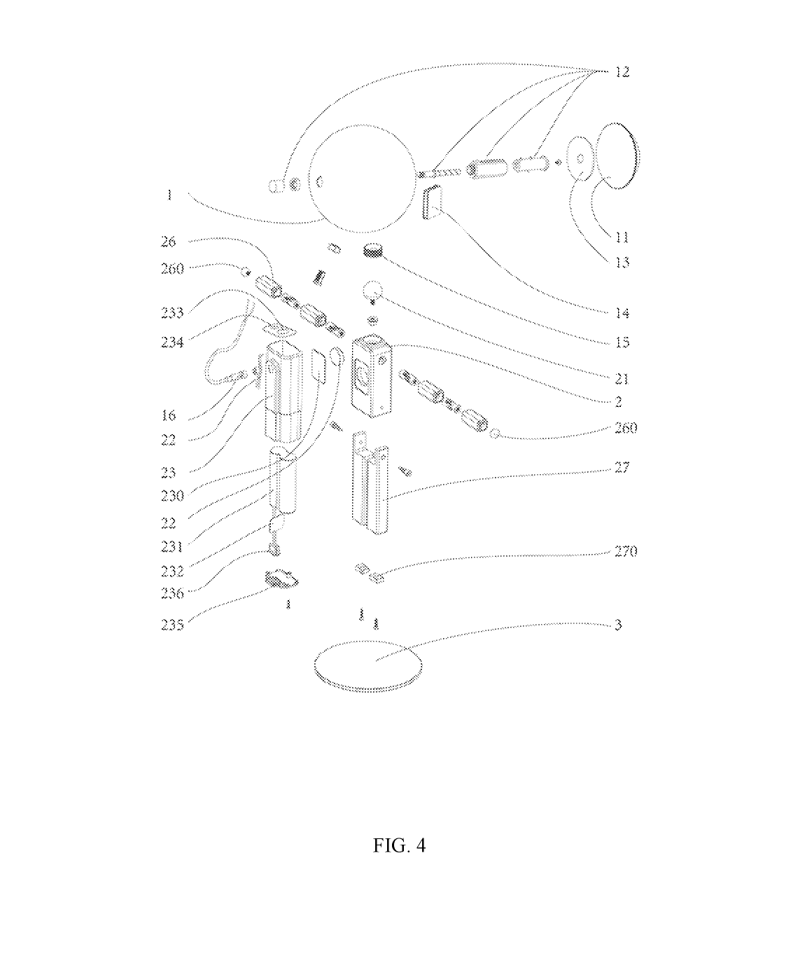

Please refer to FIG. 3 and FIG. 4. A top of the energy pack 23 is provided with a second light source assembly 233 and a switch 234. The energy pack 23 can be removed and used as an independent mobile power bank and flashlight, providing the user with backup power and an emergency lighting function in travel scenarios.

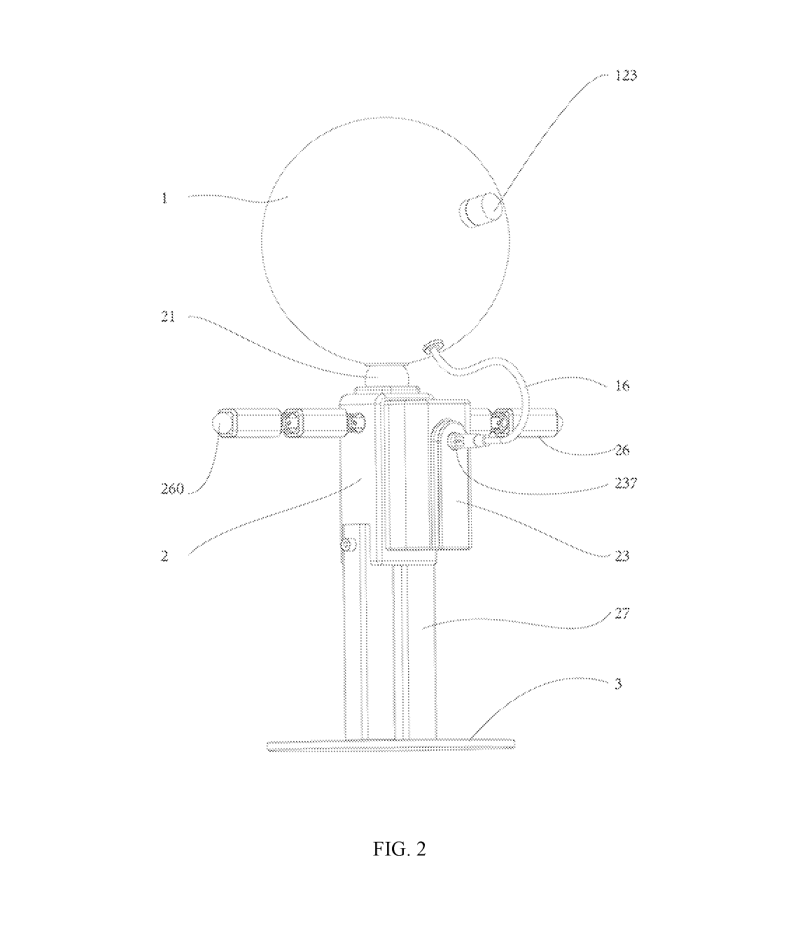

Please refer to FIG. 1 and FIG. 2. The leg 27 can rotate 360 degrees around the torso 2 to assume a bending or kicking posture, and cooperates with the focusing apparatus 12 of the head 1 to control an angle and a range of illumination. Meanwhile, legs 27 of a plurality of lamps can be magnetically attracted to each other through the fifth magnetic attraction apparatus 270 to form an array or a linked posture. In some commercial scenarios, a light show can be implemented through programming to project an advertising slogan or video images through the projection lens 110.

Although embodiments of the present disclosure have been shown and described above, it should be noted that the above embodiments are illustrative and should not be construed as limiting the present disclosure. Those skilled in the art can make equivalent changes, modifications, substitutions, and variations to the above embodiments within the scope of the present disclosure without departing from its principles and spirit. These equivalent changes, modifications, substitutions, and variations are all included within the scope defined by the claims of this application.

What is claimed is:

1. A modular humanoid interactive lamp, comprising:
a head, wherein a front of the head is provided with a face lens, a bottom of the head is provided with a first magnetic attraction apparatus, and an interior of the head is provided with a focusing apparatus; a first light source assembly is fixed to a front end of the focusing apparatus, and an integrated control assembly is fixed to a rear end of the focusing apparatus; and the integrated control assembly comprises an environmental sensor, a voice recognition chip, and a wireless communication module;
a torso, wherein a top of the torso is provided with a head connection ball, and a back of the torso is provided with a second magnetic attraction apparatus; the second magnetic attraction apparatus is connected to an energy pack, and a front of the energy pack is provided with a magnetic iron sheet for docking with the second magnetic attraction apparatus, a back of the energy pack is provided with a third magnetic attraction apparatus, the energy pack has a built-in lithium battery and a charging circuit, and a bottom of the energy pack is provided with an energy pack cover and a charging port, and the energy pack is connected to the head through the third magnetic attraction apparatus and supplies power to the head; and the torso is provided with arms on two sides, and legs on two sides of the bottom, an end of the arm is provided with a fourth magnetic attraction apparatus, and a bottom of the leg is provided with a fifth magnetic attraction apparatus; and
a base, wherein the base is made of a magnetic metal material and is capable of being connected through magnetic attraction to the fifth magnetic attraction apparatus to keep the lamp standing.

2. The modular humanoid interactive lamp according to claim 1, wherein an outermost layer of the focusing apparatus is provided with a focusing seat, a lead screw nut is fixed in an inner layer of the focusing seat, a lead screw is nested in the lead screw nut, a front end of the lead screw nut is connected and fixed to the first light source assembly, a rearmost end of the lead screw extends to the outside of the head and is fixedly connected to a focusing knob, and rotating the focusing knob is capable of rotating the lead screw in a linkage manner and moving the lead screw nut back and forth, thereby driving the first light source assembly to move back and forth, realizing a focusing control function, changing a size of a spot emitted from the face lens, and adjusting an illumination area of the lamp.

3. The modular humanoid interactive lamp according to claim 1, wherein the integrated control assembly is electrically connected to the first light source assembly, the integrated control assembly extends a magnetic terminal wire to the outside of the head and is electrically connected to the third magnetic attraction apparatus, and the energy pack provides power support to the integrated control assembly through the third magnetic attraction apparatus.

4. The modular humanoid interactive lamp according to claim 1, wherein the environmental sensor automatically adjusts brightness based on light intensity, and the voice recognition chip controls on/off and brightness/color temperature adjustment of the first light source assembly according to a voice instruction.

5. The modular humanoid interactive lamp according to claim 1, wherein the face lens is detachably replaced with a projection lens to project a dynamic image externally, and receives an external device instruction and real-time updated content through the wireless communication module, thereby achieving remote information interaction and joint interaction among a plurality of lamps.

6. The modular humanoid interactive lamp according to claim 1, wherein a top of the energy pack is provided with a second light source assembly and a switch, and the energy pack is removable and used as an independent mobile power bank and flashlight.

7. The modular humanoid interactive lamp according to claim 1, wherein the leg is capable of rotating 360 degrees around the torso to assume a bending or kicking posture, and cooperates with the focusing apparatus of the head to jointly control an angle and a range of illumination,
and meanwhile, legs of a plurality of lamps are capable of being magnetically attracted to each other through the fifth magnetic attraction apparatus to form an arranged array or a linked posture.
